(19) United States
(12) Patent Application Publication
(10) Pub. No.: US 2016/0121621 A1
(43) Pub. Date: May 5, 2016

(54) REWRITABLE PRINTER APPARATUS

(71) Applicant: TOSHIBA TEC KABUSHIKI KAISHA, Tokyo (JP)

(72) Inventor: Sadayoshi Mochida, Numazu (JP)

(21) Appl. No.: 14/529,316

(22) Filed: Oct. 31, 2014

(51) Int. Cl. B41J 2/335

(52) U.S. Cl. CPC B41J 2/335

(57) ABSTRACT

In accordance with one embodiment, a rewritable printer apparatus comprises a paper storing section configured to store a recording medium on which an image can be recorded or erased repeatedly according to the difference of applied heat energy; a conveyance module configured to convey the recording medium stored in the paper storing section; an erasing module configured to heat the recording medium conveyed by the conveyance module to erase the image recorded on the recording medium; a recording module configured to heat the recording medium conveyed by the conveyance module to record an image; a temperature detection module configured to detect the temperature of the paper storing section; and a heating module configured to heat the paper storing section based on the temperature detected by the temperature detection module.

### FIELD

Embodiments described herein relate to a rewritable printer apparatus capable of carrying out printing repeatedly.

### BACKGROUND

In order to reduce the printing paper consumption amount, there is known a rewritable printer apparatus for reusing printing paper. The rewritable printer apparatus uses rewritable paper which can be printed and erased by heating.

A reversible thermosensitive recording layer containing leuko dye and color developing agent and the like is overlaid on the surface of the rewritable paper, and the print content is fixed through rapid cooling after heating and erased through slow cooling after heating. The erasing processing is carried out using the erasing apparatus, and the rewritable paper printed with given print content is picked up by a pickup roller and the like one by one, and is applied with heat energy required to erase by a heat generator such as a heat roller, and is then cooled slowly to erase the print content. Then, new printing is carried out on the rewritable paper the printing on which is erased.

In order to erase the printing, it is necessary to apply heat energy required to erase according to the characteristic of the rewritable paper. The heat energy is applied to the rewritable paper, which is picked up one by one, by a heat generator such as a heat roller. The quantity of the heat energy is determined on the assumption that the energy applied from a heat roller and the like is applied to one piece of paper. Thus, in a case where the rewritable paper sticks to each other due to static electricity and the like, the heat energy for erasing becomes insufficient and the printing content cannot be erased completely. Thus, it is confirmed whether or not the rewritable paper sticks to each other, and if it does, it is known that more heat energy for erasing needs to be applied.

However, in a case where the apparatus is used in a state in which the temperature outside is lower than a maker warranty use temperature of the rewritable paper, there is a risk that the heat energy required to erase the printing is insufficient.

### BRIEF DESCRIPTION OF THE DRAWINGS

FIG. 1 is a constitution diagram illustrating the main portions of a rewritable printer apparatus according to one embodiment;

FIG. 2 is a control block diagram illustrating the rewritable printer apparatus according to the present embodiment;

FIG. 3 is a flowchart illustrating the operations carried out by the rewritable printer apparatus according to the present embodiment;

FIG. 4 is an illustration diagram illustrating the positions of a heating module according to the present embodiment;

FIG. 5 is a flowchart illustrating the operations carried out by a rewritable printer apparatus according to a second embodiment;

FIG. 6 is a constitution diagram illustrating the main portions of a rewritable printer apparatus according to a third embodiment;

FIG. 7 is a flowchart illustrating the operations carried out by a rewritable printer apparatus according to a fourth embodiment; and

FIG. 8 is a data table illustrating the relation between the temperature of a paper storing section and the conveyance speed according to the fourth embodiment.

### DETAILED DESCRIPTION

In accordance with one embodiment, a rewritable printer apparatus comprises a paper storing section configured to store a recording medium on which an image can be recorded or erased repeatedly according to the difference of applied heat energy; a conveyance module configured to convey the recording medium stored in the paper storing section; an erasing module configured to heat the recording medium conveyed by the conveyance module to erase the image recorded on the recording medium; a recording module configured to heat the recording medium conveyed by the conveyance module to record an image; a temperature detection module configured to detect the temperature of the paper storing section; and a heating module configured to heat the paper storing section based on the temperature detected by the temperature detection module.

### A First Embodiment

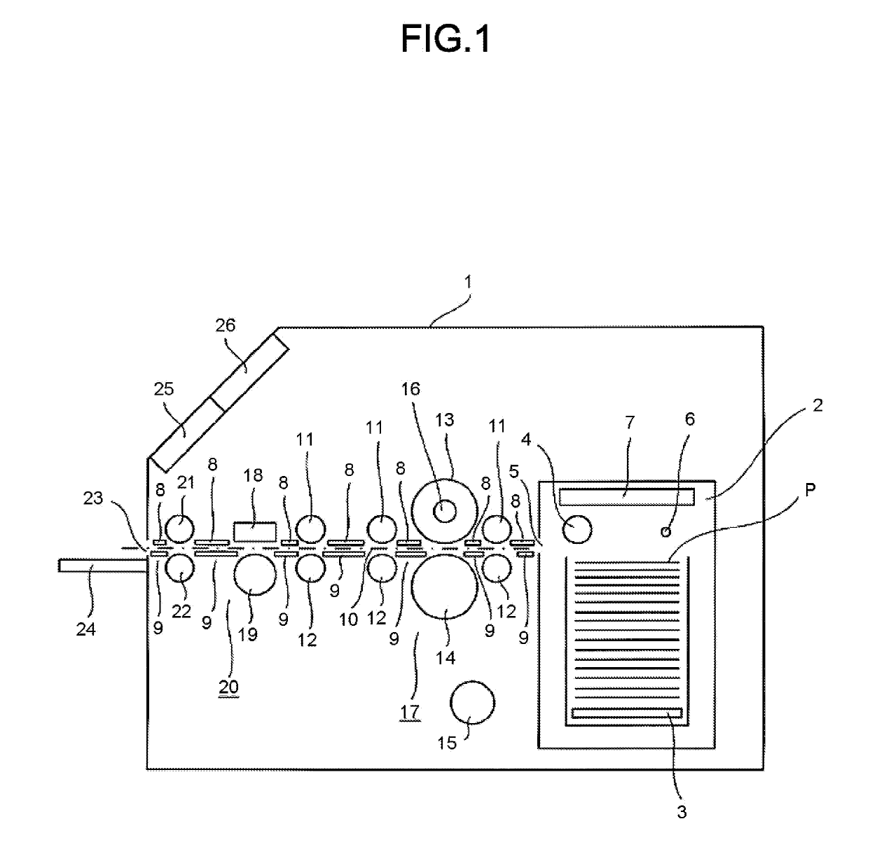

Hereinafter, the rewritable printer apparatus according to the first embodiment is described in detail with reference to FIG. 1-FIG. 4.

FIG. 1 is a constitution diagram illustrating the main portions of the rewritable printer apparatus according to the first embodiment.

A paper storing section 2 for storing rewritable paper P is arranged at the rear portion of a rewritable printer apparatus 1, and a discharge port 23 for discharging the printed rewritable paper P to the outside of the rewritable printer apparatus 1 is arranged at the front side of the rewritable printer apparatus 1. The rewritable paper P is conveyed inside the rewritable printer apparatus 1 from the paper storing section 2 towards the discharge port 23. In the following description, the right side in the figure is referred to as the upstream side and the left side is referred to as the downstream side.

The paper storing section 2 is arranged at the most upstream part of the rewritable printer apparatus 1. A vertically movable lifter 3 is arranged at the lower portion of the paper storing section 2, and a plurality of sheets of rewritable paper P is stacked on the lifter 3. Further, a pickup roller 4 is arranged in the paper storing section 2. The lifter 3 lifts the stacked rewritable paper P upwards so that the pickup roller 4 can pick up and convey, through rotation, the upmost rewritable paper P of the stacked rewritable paper P merely.

A storing section discharge port 5 is arranged in the paper storing section 2, and the rewritable paper P picked up by the pickup roller 4 is conveyed from the storing section discharge port 5 to the downstream side. Further, a temperature sensor 6 and a heater 7 which will be described later are arranged in the paper storing section 2.

Conveyance upper guides 8 and conveyance lower guides 9 are arranged to extend from the storing section discharge port 5 to the discharge port 23, and the space between the conveyance upper guides 8 and the conveyance lower guides 9 is used as a paper conveyance path 10 for conveying the rewritable paper P.

At the downstream side of the paper storing section 2, feed rollers 11 which can be rotated by a motor (not shown) are arranged opposite to idle rollers 12 across the paper conveyance path 10. These feed rollers 11 and idle rollers 12 are in pair to clamp and convey the rewritable paper P. In addition, a plurality of pairs of feed rollers 11 and idle rollers 12 is arranged along the paper conveyance path 10.

At the downstream side of the paper storing section 2, a press roller 14 which can be rotated by a press motor 15 is arranged opposite to a heat pipe 13 across the paper conveyance path 10. Further, a heater 16 is arranged in the heat pipe 13 as a heat source, and the rewritable paper P clamped between the press roller 14 and the heat pipe 13, which is heated by the heater 16, is heated to erase the print content recorded thereon. The heat pipe 13, the press roller 14, the press motor 15 and the heater 16 constitute an erasing section 17.

At the downstream side of the erasing section 17, a thermal print head 18 is arranged opposite to a platen roller 19 across the paper conveyance path 10. The thermal print head 18 and the platen roller 19 constitute a printing section 20 which carries out printing on the rewritable paper P.

At the downstream side of the printing section 20, a discharge roller 21 is arranged opposite to a discharge idle roller 22 across the paper conveyance path 10. The rewritable paper P printed by the printing section 20 is then discharged to the outside of the rewritable printer apparatus 1 from the discharge port 23 through the cooperation between the discharge roller 21 and the discharge idle roller 22. Further, a discharge table 24 is arranged below the discharge port 23 to hold the rewritable paper P discharged from the discharge port 23 so that the rewritable paper P won't fall.

An operation section 25 for carrying out various settings of the rewritable printer apparatus 1 and a display section 26 for displaying the setting state or an error of the rewritable printer apparatus 1 are arranged above the discharge port 23.

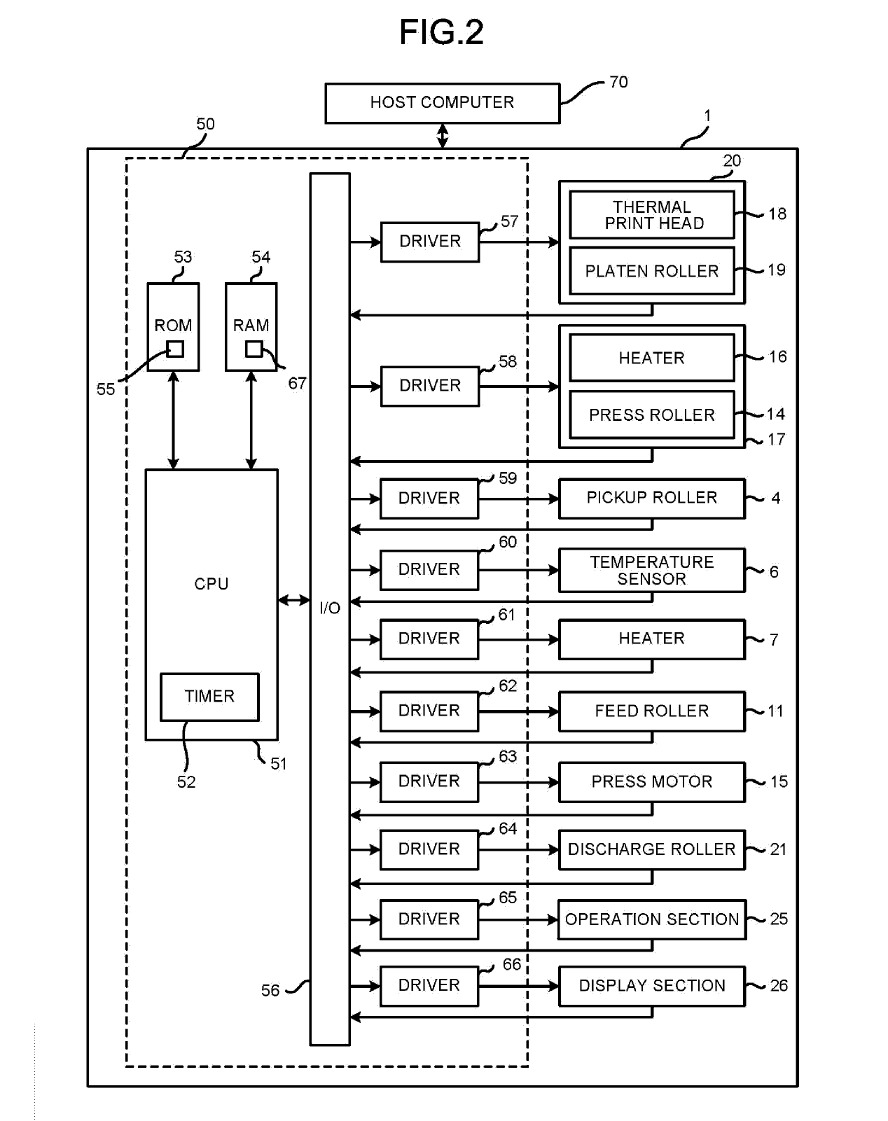

FIG. 2 is a block diagram illustrating the control circuit constitution of the rewritable printer apparatus 1 according to the first embodiment. A control section 50 controls the paper conveyance, the temperature measurement, the heating of the paper storing section, the erasing of the printing, the printing, the paper discharge, the display of the situation of the rewritable printer apparatus, and the like.

The control section 50 is constituted by, for example, a micro-computer which carries out connection with a host computer 70 and the execution of various controls.

A center processing unit (CPU) 51 of the control section 50 carries out, according to programs, various controls such as paper conveyance control, temperature measurement control, paper storing section heating control, erasing control, printing control, paper discharge control and situation display control, and execution.

The CPU 51 comprises a timer 52 serving as a unit for carrying out time setting and time control.

A ROM 53 and a RAM 54 are arranged in the control section 50 as primary storage units for storing control programs executed by the CPU 51, data generated during a control process or an operation process, and the like.

The ROM 53 is a read-only memory in which control programs, tables and the like are stored, and the RAM 54 is a random access memory for storing the data generated during an operation process.

A heating instruction section 55 which will be described later is arranged in the ROM 53 to give a heating instruction to the heater 7 according to the temperature measured by the temperature sensor 6. Further, a printing data storage section 67 is arranged in the RAM 54 to temporarily store the printing data sent from the host computer 70.

An input/output unit (I/O) 56 is arranged in the control section 50 to acquire various input data from the host computer 70 and export a control output of the control section 50 to the host computer 70. The I/O 56 is connected with the CPU 51, the ROM 53 and the RAM 54 via a bus line.

The I/O 56 is connected with a first, a second, a third, a fourth, a fifth, a sixth, a seventh, an eighth, a ninth and a tenth driver 57, 58, 59, 60, 61, 62, 63, 64, 65 and 66 serving as units for exporting a control output.

The first driver 57 supplies a required drive output for the printing section 20. The second driver 58 supplies a required drive output for the erasing section 17. The third driver 59 supplies a required drive output for the pickup roller 4. The fourth driver 60 supplies a required drive output for the temperature sensor 6. The fifth driver 61 supplies a required drive output for the heater 7. The sixth driver 62 supplies a required drive output for feed roller 11. The seventh driver 63 supplies a required drive output for the press motor 15. The eighth driver 64 supplies a required drive output for the discharge roller 21. The ninth driver 65 supplies a required drive output for the operation section 25. The tenth driver 66 supplies a required drive output for the display section 26.

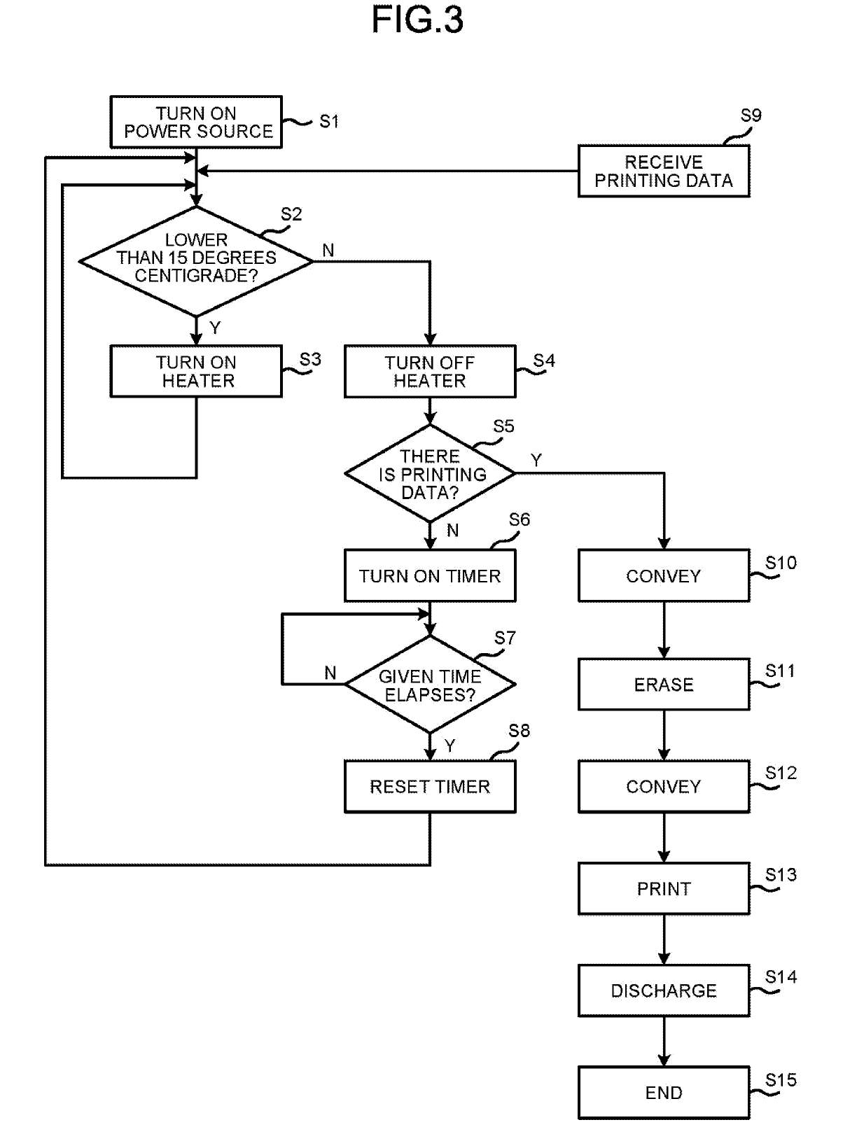

The operations of the rewritable printer apparatus 1 are described below with reference to FIG. 3.

The rewritable printer apparatus 1 first erases the previous printing recorded on the rewritable paper P and then carries out new printing. If new printing is carried out on the rewritable paper P on which the previous printing is not erased completely, the new printing and the previous printing are overlapped, which leads to a problem that the new printing is hard to read. Thus, it is preferred to completely erase the previous printing. The erasing operation is carried out by the erasing section 17 by applying required heat energy to the rewritable paper P. The quantity of the heat energy is determined according to the temperature and the conveyance speed of the rewritable paper P. Generally, the conveyance speed is constant, while the temperature of the rewritable paper P changes depending on the arrangement place of the rewritable printer apparatus 1 and the like. Thus, the quantity of heat energy applied in the erasing processing is set to be such a quantity level at which a complete erasing processing can be carried out even if the temperature of the rewritable paper P is the lower limit temperature of the maker warranty use temperature of the rewritable paper P. However, in a case of a temperature lower than the lower limit temperature of the warranty use temperature of the rewritable paper P, only a quantity of heat energy less than the quantity of heat energy with which the printing on the paper can be erased is applied, thus, the printing cannot be completely erased. Thus, in the rewritable printer apparatus 1, it is necessary to always maintain the rewritable paper P at a temperature higher than the lower limit temperature of the warranty use temperature of the rewritable paper P.

A user opens a cover and the like (not shown) of the rewritable printer apparatus 1 to load the rewritable paper P in the paper storing section 2. The rewritable paper P is a recording medium which includes a reversible thermosensitive recording layer and the like as a coloring source, and the reversible thermosensitive recording layer contains leuko dye and color developing agent and the like and indicates two states of color generation and color erasing according to the difference of applied heat energy. In addition, though the rewritable paper P may be either of paper printed with information and blank paper, in the present embodiment, the rewritable paper P printed with information is stacked.

If the power source of the main body of the rewritable printer apparatus 1 is turned on (S1), the control section 50 measures the temperature of the paper storing section 2 with the temperature sensor 6, and determines whether or not the measured value is less than 15 degrees centigrade (S2). Though the determination temperature is set to 15 degrees centigrade herein, the temperature is the lower limit temperature of the maker warranty use temperature of the used rewritable paper P. Thus, it is necessary to change the setting of the determination temperature according to the lower limit temperature of the maker warranty use temperature of the used rewritable paper P. In the present embodiment, it is exemplified that the rewritable paper P is used of which the lower limit temperature of the maker warranty use temperature is 15 degrees centigrade.

If the value measured by the temperature sensor 6 is less than 15 degrees centigrade (YES in S2), the heating instruction section 55 drives the heater 7 arranged in the paper storing section 2 to heat the paper storing section 2 (S3). The heating processing is continued until the value measured by the temperature sensor 6 is more than 15 degrees centigrade.

If the value measured by the temperature sensor 6 is not less than 15 degrees centigrade through the heating based on the heater 7, or if the value measured by the temperature sensor 6 is already more than 15 degrees centigrade when the power source of the main body of the rewritable printer apparatus 1 is turned on (NO in S2), the control section 50 stops the heater 7 (S4). In addition, as to the stop of the heater 7, it means stopping the heater 7 when the heater 7 is being driven, while in a case where the value measured by the temperature sensor 6 is already more than 15 degrees centigrade when the power source of the main body of the rewritable printer apparatus 1 is turned on, the heating based on the heater 7 is not carried out, therefore, the heater 7 is maintained in the stop state.

Next, the control section 50 confirms whether or not there is printing data in the printing data storage section (S5). If the printing data is not received, that is, there is no printing data (NO in S5), the control section 50 turns on the timer 52 (S6) to start the time measurement.

Then, the control section 50 confirms whether or not a given time has elapsed since the timer 52 is turned on (S7). As state above, it is confirmed whether or not the temperature of the paper storing section 2 is lower than 15 degrees centigrade (S2), and if the temperature is lower than 15 degrees centigrade (YES in S2), the heater 7 is turned on (S3), however, if the temperature is higher than 15 degrees centigrade (NO in S2), the temperature of the paper storing section 2 is higher than 15 degrees centigrade serving as the lower limit temperature of the maker warranty use temperature of the rewritable paper P, thus, it is possible to erase the printing on the rewritable paper P merely with the heat energy applied during the erasing processing by the erasing section 17. Thus, as it is not necessary to turn on the heater 7 to carry out heating, the heater is turned off. However, in a case where the heater 7 is turned off, it is considered that, for example, the temperature outside the rewritable printer apparatus 1 is low, and as a result, the temperature of the paper storing section 2 soon becomes lower than 15 degrees centigrade serving as the lower limit temperature of the maker warranty use temperature of the rewritable paper P. In this case, it is impossible to erase the printing on the rewritable paper P merely with the heat energy applied during the erasing processing by the erasing section 17. As stated above, even if the temperature of the paper storing section 2 is higher than 15 degrees centigrade serving as the lower limit temperature of the maker warranty use temperature of the rewritable paper P through the heating based on the heater 7, it is necessary to confirm, at regular time intervals, whether or not the temperature of the paper storing section 2 is lower than 15 degrees centigrade serving as the lower limit temperature of the maker warranty use temperature of the rewritable paper P. The time for carrying out reconfirmation on the temperature of the paper storing section 2 is the given time. It is confirmed whether or not the given time elapses (S7), and if the given time does not elapse (NO in S7), the reconfirmation on the temperature of the paper storing section 2 is not carried out until the given time elapses. It is confirmed whether or not the given time elapses (S7), and if the given time elapses (YES in S7), a next reconfirmation on the temperature of the paper storing section 2 is carried out, thus, the timer for measuring the given time is reset (S8), and then the flow returns to measure the temperature of the paper storing section 2 again. In this way, the control section 50 measures the temperature of the paper storing section 2, and drives the heater 7 as needed, so as to maintain a state in which the temperature of the paper storing section 2 is always higher than 15 degrees centigrade serving as the lower limit temperature of the maker warranty use temperature of the rewritable paper P.

If the control section 50 receives printing data from the host computer 70 in the state in which the temperature of the paper storing section 2 is always higher than 15 degrees centigrade serving as the lower limit temperature of the maker warranty use temperature of the rewritable paper P (S9), the control section 50 measures the temperature of the paper storing section 2 again (S2).

Though the temperature of the paper storing section 2 is already higher than 15 degrees centigrade at this time, suppose that the temperature is lower than 15 degrees centigrade (YES in S2), it waits and carries out heating with the heater 7 until the temperature is higher than 15 degrees centigrade. If the temperature is higher than 15 degrees centigrade (NO in S2), the heater 7 is turned off (S4), and it is confirmed again whether or not there is printing data (S5). As stated above, as the printing data is received at this time (YES in S5), the pickup roller 4 is rotated to merely pick up the upmost rewritable paper P of the rewritable paper P loaded in the paper storing section 2, and to convey the upmost rewritable paper P to the downstream side from the storing section discharge port 5. Then, the rewritable paper P is conveyed to the erasing section 17 through the cooperation between the feed roller 11 and the idle roller 12 (S10).

The erasing section 17 conveys the clamped rewritable paper P to the downstream side through the cooperation between the heat pipe 13 and the press roller 14. In addition, the conveyance is carried out using the driving force applied to the press roller 14 by the press motor 15. Further, the heater 16 heats the heat pipe 13 from inside, and through the heating, the printing on the rewritable paper P is erased while the rewritable paper P is clamped and conveyed by the heat pipe 13 and the press roller 14 (S11).

The rewritable paper P the printing on which is erased is then conveyed to the printing section 20 through the cooperation between the feed roller 11 and the idle roller (S12). The print content on the rewritable paper P conveyed to the printing section 20 is erased at this time. The data in the printing data storage section 67 is printed on the rewritable paper P through the cooperation between the thermal print head 18 and the platen roller 19 (S13). The rewritable paper P subjected to printing processing is then discharged out of the rewritable printer apparatus 1 from the discharge port 23 through the cooperation between the discharge roller 21 and the discharge idle roller 22 (S14), and then the printing is ended (S15).

As stated above, in accordance with the present embodiment, the temperature of the paper storing section 2 is measured, and heating processing is carried out by the heater 7 based on the temperature detected by the temperature detection module so as to maintain a state in which the temperature of the paper storing section 2 is always higher than the maker warranty use temperature of the rewritable paper P. In this way, the heat energy applied by the erasing section 17 to erase the printing on the rewritable paper P is not changed according to the temperature outside and the like, and the printing on the rewritable paper P can be erased by the erasing section 17.

Further, as the temperature of the paper storing section 2 is measured, the temperature of the rewritable paper P can be known correctly compared with the measurement value of the temperature outside.

Further, there is a method in which the heating function is merely included in the erasing section 17, and in a case where the temperature outside is low, more (compared with the general quantity) heat energy is applied to the rewritable paper P by the heater 16 to erase the printing; however, in this method, it is necessary to supply a large current at a time. Thus, it is necessary to enlarge the capacity of the power source. However, in the present embodiment, the peak of the heating of the paper storing section 2 and the peak of the heating of the erasing section 17 are not consistent. Thus, compared with the case of supplying a large current at a time, it is possible to reduce the capacity of the power source.

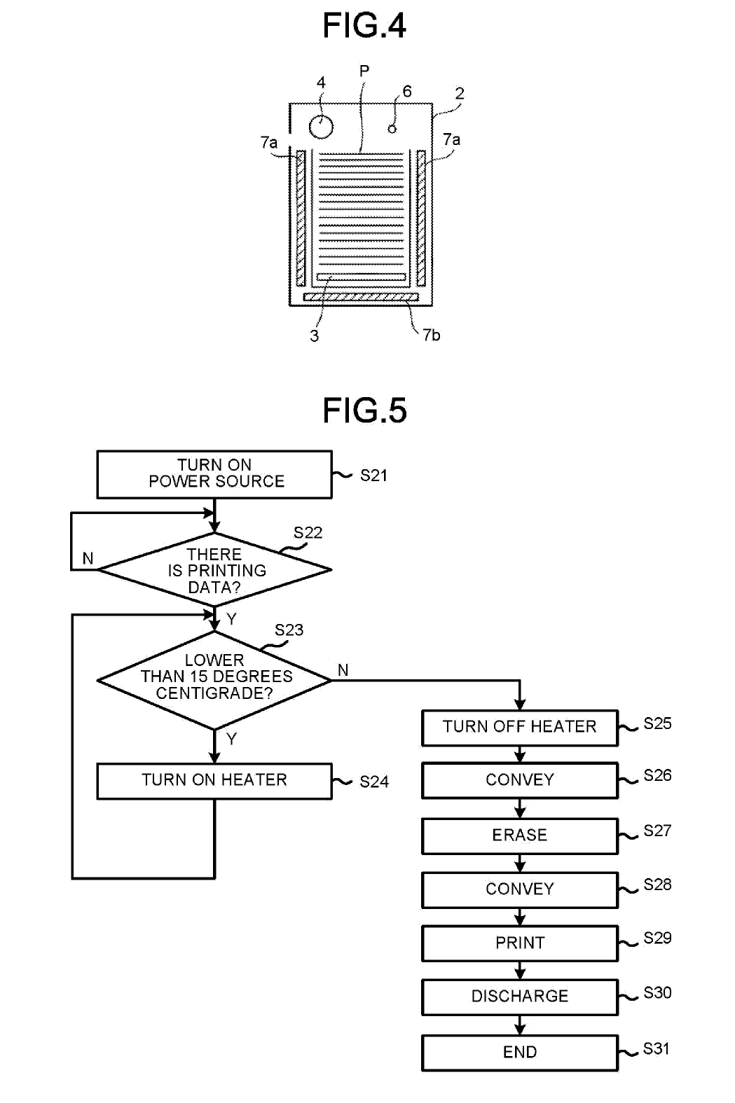

In the present embodiment, the heater 7 of the paper storing section 2 is arranged at the upper portion of the paper storing section 2, however, the present invention is not limited to this. For example, the heater may be arranged at one sidewall of the paper storing section 2, as shown by heaters 7a in FIG. 4; or be arranged at the lower portion of the paper storing section 2, as shown by a heater 7b in FIG. 4.

### A Second Embodiment

Hereinafter, the rewritable printer apparatus 1 according to the second embodiment is described in detail with reference to FIG. 5. In addition, the description of the same components as those described in the first embodiment is omitted.

In the first embodiment, if the power source of the main body of the rewritable printer apparatus 1 is turned on, first, the temperature of the paper storing section 2 is measured with the temperature sensor 6 and it is determined whether or not the value measured by the temperature sensor 6 is less than 15 degrees centigrade. The heater 7 is turned on to carry out heating processing as needed according to the result of the temperature measurement, so as to make the temperature of the paper storing section 2 higher than the lower limit temperature of the maker warranty use temperature of the rewritable paper P. In this way, due to the heating by the heater 7, the temperature of the paper storing section 2 is higher than the lower limit temperature of the maker warranty use temperature of the rewritable paper P when the printing data is received, and then the printing data is received and the erasing and printing processing is carried out.

However, if such a control is carried out, the apparatus stands by in such a state in which the temperature of the paper storing section 2 is always higher than the lower limit temperature of the maker warranty use temperature of the rewritable paper P, thus, the heating is carried out by the heater 7 all the way until the printing data is received. Especially, in a case where the printing data is not received for a long time in a low temperature environment, or in other cases, the heat energy is not used to do anything, which is a waste of energy.

About this point, in the second embodiment, the measurement of the temperature of the paper storing section 2 is not started until the data is received, and then the paper storing section 2 is heated by the heater 7 as needed.

If the power source of the main body of the rewritable printer apparatus 1 is turned on (S21), the control section 50 checks whether or not there is printing data in the printing data storage section 67 arranged in the RAM 54 (S22). If there is no printing data (NO in S22), it waits until the printing data is received.

The control section 50 confirms whether or not there is printing data stored in the printing data storage section 67, and if there is printing data (YES in S22), the temperature of the paper storing section 2 is measured by the temperature sensor 6, and it is determined whether or not the measured value is less than 15 degrees centigrade (S23).

If the value measured by the temperature sensor 6 is less than 15 degrees centigrade (YES in S23), the heating instruction section 55 drives the heater 7 arranged in the paper storing section 2 to heat the paper storing section 2 (S24). The heating processing is continued until the value measured by the temperature sensor 6 is more than 15 degrees centigrade.

If the value measured by the temperature sensor 6 is more than 15 degrees centigrade through the heating based on the heater 7, or if the value measured by the temperature sensor 6 is more than 15 degrees centigrade at the time when the printing data is received (NO in S23), the control section 50 turns off the heater 7 (S25). In addition, in the present embodiment, the heater 7 is stopped in a case where the heater 7 is being driven, while in a case where the value measured by the temperature sensor 6 is more than 15 degrees centigrade at the time when the printing data is received, the heating based on the heater 7 is not carried out, therefore, the heater 7 is maintained in the stop state.

Next, the control section 50 rotates the pickup roller 4 to merely pick up the upmost rewritable paper P of the rewritable paper P loaded in the paper storing section 2, and to convey the upmost rewritable paper P to the downstream side from the storing section discharge port 5. Then, the rewritable paper P is conveyed to the erasing section 17 through the cooperation between the feed roller 11 and the idle roller 12 (S26).

Then, like in the first embodiment, the erasing processing is carried out by the erasing section 17 (S27), and then the rewritable paper P is conveyed (S28), printed (S29), and then discharged (S30), then, the printing is ended (S31).

In this way, as the temperature of the paper storing section 2 is measured after the data is received in the second embodiment, the heating based on the heater 7 is not carried out until the printing data is received. In this way, it is possible to prevent that the heat energy applied by the heater 7 in the standby state is wasted.

In addition, the same as the first embodiment, in the second embodiment, the heater 7 may be arranged at one sidewall of the paper storing section 2, as shown by the heaters 7a in FIG. 4; or be arranged at the lower portion of the paper storing section 2, as shown by the heater 7b in FIG. 4.

### A Third Embodiment

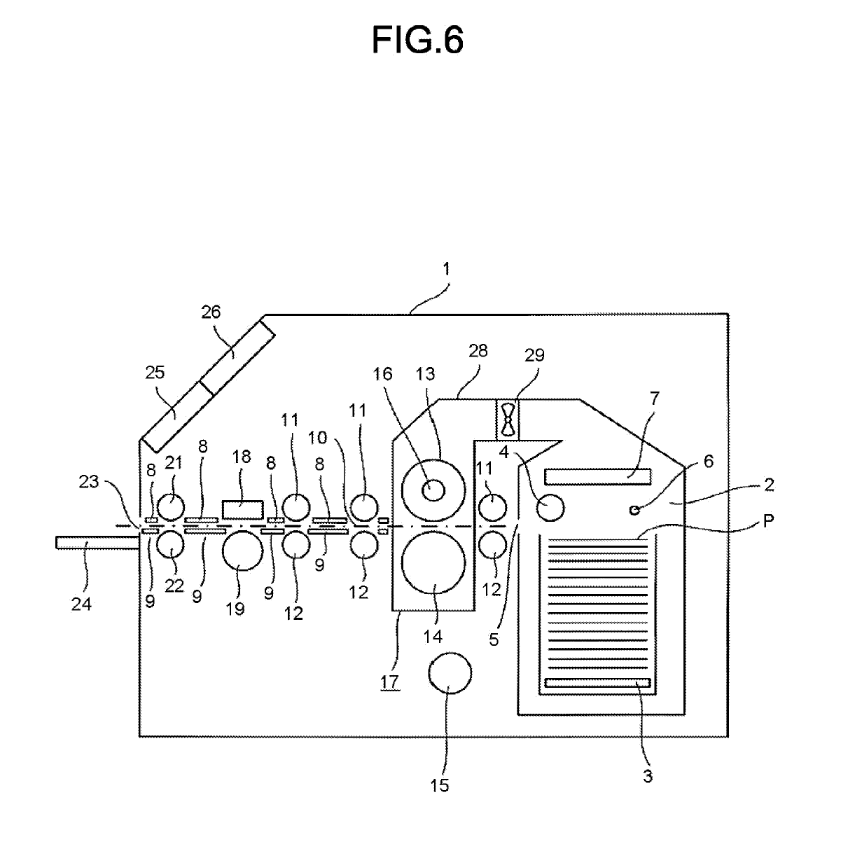

Hereinafter, the rewritable printer apparatus according to the third embodiment is described in detail with reference to FIG. 6. In addition, the description of the same components as those described in the first embodiment and the second embodiment is omitted.

The erasing section 17 is arranged in the rewritable printer apparatus 1 to erase the printing recorded on the rewritable paper P. The heater 16 is arranged inside the heat pipe 13 of the erasing section 17. The heater 16 generates heat to keep the temperature at, for example, 185 degrees centigrade, so that it is possible to apply heat energy for the erasing processing whenever the rewritable paper P to be erased is conveyed to the erasing section 17. However, the heat energy is just released to the outside when erasing processing is not carried out.

In the third embodiment, the paper storing section 2 is heated by circulating the heat energy, which is just released to the outside when erasing processing is not carried out, in the paper storing section 2, and in this way, the amount of heat applied to the paper storing section 2 by the heater 7 can be reduced.

As shown in FIG. 6, the paper storing section 2 and the erasing section 17 of the rewritable printer apparatus 1 are communicated through a passage 28.

When erasing processing is not carried out, the heat energy, which is just released from the heater 16 to the outside instead of being used, is circulated through the passage 28 to heat the paper storing section 2. Thus, compared with the case where the paper storing section 2 is heated merely by the heater 7, the amount of heat applied by the heater 7 can be reduced.

Further, if a fan motor 29 is arranged in the middle of the passage 28 which communicates the erasing section 17 and the paper storing section 2, more heat generated by the heater 16 of the erasing section 17 is circulated in the paper storing section 2, which can further reduce the amount of heat applied by the heater 7. However, if the fan motor 29 is driven, a quantity (more than necessary) of heat generated by the heater 16 of the erasing section 17 is circulated in the paper storing section 2, which leads to a risk that the heat energy required to carry out erasing processing is insufficient. Thus, it is preferred to stop the fan motor 29 during the erasing processing.

### A Fourth Embodiment

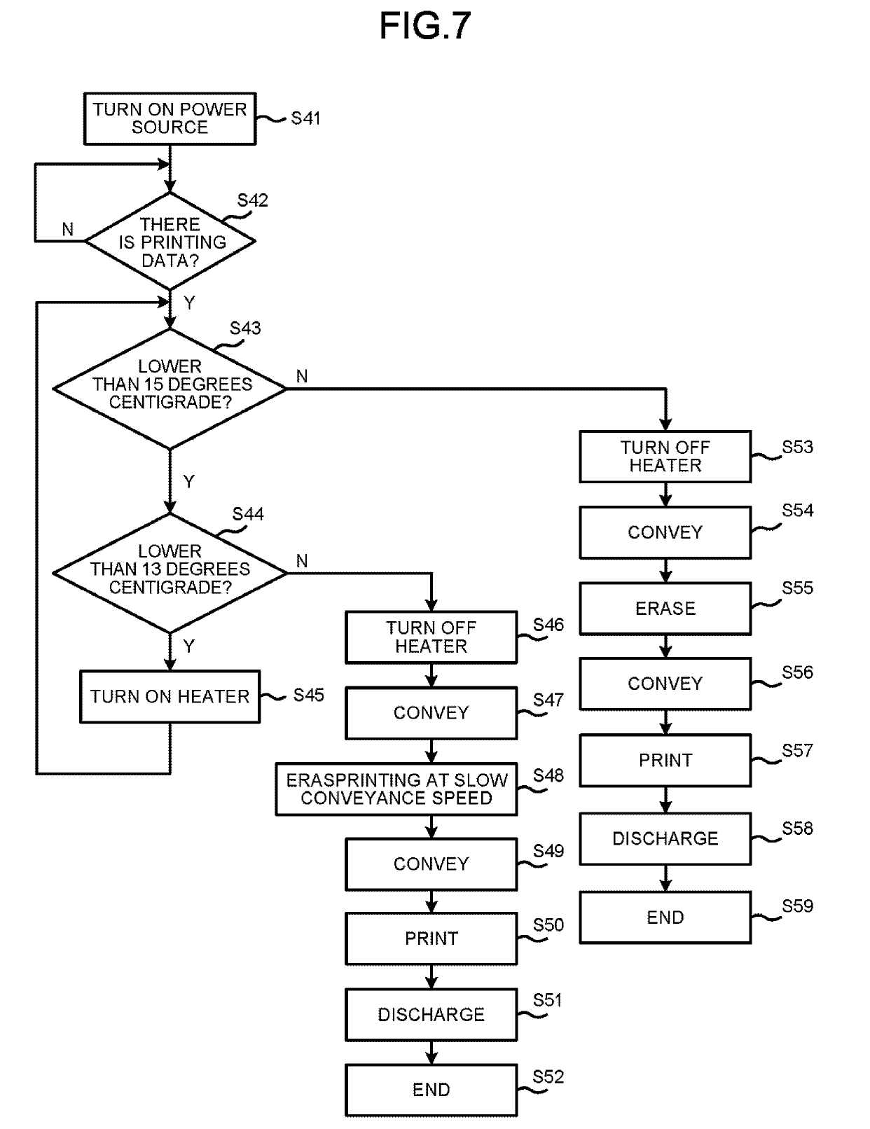

Hereinafter, the rewritable printer apparatus according to the fourth embodiment is described in detail with reference to FIG. 7.

The temperature of the paper storing section 2 is measured, and the paper storing section 2 is heated if the temperature of the paper storing section 2 is lower than the lower limit temperature of the maker warranty use temperature of the rewritable paper P, thus, it is possible to reduce the peak of the occurrence of the heat energy in the erasing processing. However, the erasing and printing processing is not carried out until the temperature of the paper storing section 2 is higher than the lower limit temperature of the maker warranty use temperature of the rewritable paper P. Suppose that the rewritable printer apparatus 1 is used in a low temperature environment, a lot of time is taken to heat the paper storing section 2, which leads to a problem that the rewritable printer apparatus 1 cannot be used until the paper storing section 2 is heated.

In the fourth embodiment, the heat energy generated by the heater 16 of the erasing section 17 is not changed, while the conveyance speed of the rewritable paper P passing through the erasing section 17 is changed, so as to increase the heat energy applied to the rewritable paper P for the erasing processing.

The heat energy required to carry out erasing processing by the erasing section 17 is applied to the rewritable paper P to erase the printing, however, the applied heat energy is set so that a complete erasing processing can be carried out even if the temperature of the rewritable paper P is the lower limit temperature of the maker warranty use temperature and the rewritable paper P is passed through the erasing section 17 at a pre-determined conveyance speed. In a case where the temperature of the rewritable paper P is lower than the lower limit temperature of the maker warranty use temperature, the pre-determined conveyance speed is reduced to increase the time of clamping the rewritable paper P between the heat pipe 13 and the press roller 14, thereby increasing the heat energy applied to the rewritable paper P within the unit time. As the conveyance speed is changed, it is not necessary to carry out a control to change the amount of heat generated by the heater 16.

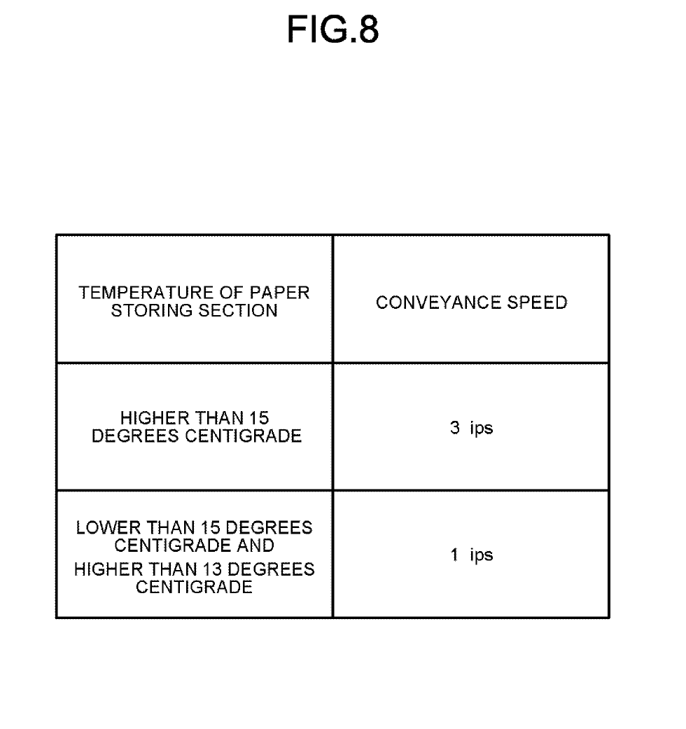

A table shown in FIG. 8 illustrates the relation between the temperature of the paper storing section 2 and the conveyance speed, and as long as the relation is maintained, the printing on the rewritable paper P can be erased. In addition, the table is stored in a conveyance speed changing section (not shown) arranged in the ROM 53.

If the power source of the main body of the rewritable printer apparatus 1 is turned on (S41), the control section 50 checks whether or not there is printing data (S42). If there is no printing data (NO in S42), it waits until the printing data is received.

If the control section 50 determines that there is printing data (YES in S42), the temperature of the paper storing section 2 is measured by the temperature sensor 6, and it is determined whether or not the measured value is less than 15 degrees centigrade (S43). If the temperature is lower than 15 degrees centigrade (YES in S43), it is determined whether or not the temperature is lower than 13 degrees centigrade (S44). If the temperature is lower than 13 degrees centigrade (YES in S44), the heating instruction section 55 drives the heater 7 to heat the paper storing section 2 (S45). The heating processing is continued until the temperature value measured by the temperature sensor 6 reaches any value shown in FIG. 8.

If the value measured by the temperature sensor 6 is less than 15 degrees centigrade and more than 13 degrees centigrade through the heating based on the heater 7 (NO in S44), the control section 50 turns off the heater 7 (S46). Next, the control section 50 rotates the pickup roller 4 to merely pick up the upmost rewritable paper P of the rewritable paper P loaded in the paper storing section 2, and to convey the upmost rewritable paper P to the downstream side from the storing section discharge port 5. Then, the rewritable paper P is conveyed to the erasing section 17 through the cooperation between the feed roller 11 and the idle roller 12 (S47).

A first erasing sensor (not shown) is arranged at the upstream side of the erasing section 17 and a second erasing sensor (not shown) is arranged at the downstream side of the erasing section 17 to recognized the existence of the rewritable paper P. If the front end of the rewritable paper P conveyed through the cooperation between the feed roller 11 and the idle roller 12 is recognized by the first erasing sensor, the conveyance speed changing section (not shown) gives, according to the table shown in FIG. 8 as one example, an instruction to change the conveyance speed to 1 ips (inches per second) serving as the conveyance speed slower than 3 ips serving as the conveyance speed of the rewritable paper P in a case where the temperature is higher than 15 degrees centigrade and is higher than the lower limit temperature of the maker warranty use temperature of the rewritable paper P, and then convey the rewritable paper P at the speed. In addition, the changing of the conveyance speed is realized by changing the rotation number of the press motor 15 and the rotation number of the feed roller 11.

In this way, the conveyance speed of the rewritable paper P clamped and conveyed inside the erasing section 17 is reduced to erase the printing (S48). If the second erasing sensor recognizes that the rear end of the erased rewritable paper P went out of the erasing section 17, the conveyance speed changing section (not shown) changes the rotation number of the press motor 15 and the rotation number of the feed roller 11 to return the conveyance speed to 3 ips serving as the conveyance speed of the rewritable paper P in a case where the temperature is higher than 15 degrees centigrade and is higher than the lower limit temperature of the maker warranty use temperature of the rewritable paper P, and then the rewritable paper P is conveyed (S49), printed (S50) and discharged (S51), and after this, the printing is ended (S52).

If the value measured by the temperature sensor 6 is more than 15 degrees centigrade due to the heating based on the heater 7, or if the value measured by the temperature sensor 6 is already more than 15 degrees centigrade when the power source of the main body of the rewritable printer apparatus 1 is turned on (NO in S43), the control section 50 stops the heater 7 (S53). In addition, as to the stop of the heater 7, it means stopping the heater 7 when the heater 7 is being driven, while in a case where the value measured by the temperature sensor 6 is already more than 15 degrees centigrade when the power source of the main body of the rewritable printer apparatus 1 is turned on, the heating based on the heater 7 is not carried out, therefore, the heater 7 is maintained in the stop state.

Next, the control section 50 rotates the pickup roller 4 to merely pick up the upmost rewritable paper P of the rewritable paper P loaded in the paper storing section 2, and to convey the upmost rewritable paper P to the downstream side from the storing section discharge port 5. Then, the rewritable paper P is conveyed to the erasing section 17 through the cooperation between the feed roller 11 and the idle roller 12 (S54).

The first erasing sensor (not shown) and the second erasing sensor (not shown) are arranged in the erasing section 17 to recognize the entrance of the rewritable paper P into the erasing section 17 and the conveyance to the outside of the erasing section 17 as stated above. However, as the conveyance speed changing section (not shown) instructs, according to the table shown in FIG. 8, to make the conveyance speed the same as general speed to convey the rewritable paper P at a speed of 3 ips, the rotation number of the press motor 15 and the rotation number of the feed roller 11 are not changed. Then the rewritable paper P is erased (S55), conveyed (S56), printed (S57) and discharged (S58), and then the printing is ended (S59).

In the present embodiment, the temperatures are divided into two ranges, that is, lower than 15 degrees centigrade but higher than 13 degrees centigrade, and lower than 13 degrees centigrade; and the conveyance speed is changed according to the two ranges; however, the present invention is not limited to this. For example, the range of the measured temperature may be divided more finely to change the conveyance speed of the rewritable paper P according to the ranges.

Further, though the conveyance speed is changed only in a case where the rewritable paper P is detected in the erasing section 17 by the first erasing sensor (not shown) and the second erasing sensor (not shown), the present invention is not limited to this, and it is also applicable that the temperature is measured, and the rotation number of the press motor 15 and the rotation number of the feed roller 11 are changed when the conveyance speed is determined no matter whether or not there is rewritable paper P in the erasing section 17. In this case, the first erasing sensor and the second erasing sensor are not necessary.

As stated above, in accordance with the present embodiment, even if the temperature of the paper storing section 2 is lower than the lower limit temperature of the maker warranty temperature of the rewritable paper P, by changing the conveyance speed of the rewritable paper P, can the printing on the rewritable paper P be erased without changing the amount of heat generated by the heater 16 of the erasing section 17.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A rewritable printer apparatus, comprising:
a paper storing section configured to store a recording medium on which an image can be recorded or erased repeatedly according to the difference of applied heat energy;
a conveyance module configured to convey the recording medium stored in the paper storing section;
an erasing module configured to heat the recording medium conveyed by the conveyance module to erase the image recorded on the recording medium;
a recording module configured to heat the recording medium conveyed by the conveyance module to record an image;
a temperature detection module configured to detect the temperature of the paper storing section; and
a heating module configured to heat the paper storing section based on the temperature detected by the temperature detection module.

2. The rewritable printer apparatus according to claim 1, wherein
the heating module heats the paper storing section in a case where the temperature detected by the temperature detection module is lower than a lower limit temperature of a warranty use temperature of the recording medium.

3. The rewritable printer apparatus according to claim 1, further comprising:
a printing data storage section; wherein
the heating module subsequently heats the paper storing section in a case where the printing data storage section receives printing data.

4. The rewritable printer apparatus according to claim 1, further comprising:
a passage configured to communicate the paper storing section and the erasing section and circulate the heat of the erasing section in the paper storing section.

5. The rewritable printer apparatus according to claim 4, further comprising:
an air blowing section configured to blow air from the erasing section which is not operated to the paper storing section through the passage when the printing section is operated.

6. The rewritable printer apparatus according to claim 2, further comprising:
a conveyance speed changing section configured to change the conveyance speed of the recording medium conveyed in the erasing module based on the detection result of the temperature detection module.
